(19) United States
(12) Patent Application Publication
(10) Pub. No.: US 2023/0261877 A1
(43) Pub. Date: Aug. 17, 2023

(54) BLOCKCHAIN-BASED COLLABORATIVE MAINTENANCE PLATFORM

(71) Applicant: SAP SE, Walldorf (DE)

(72) Inventor: Rahul Gujarathi, Walldorf (DE)

(21) Appl. No.: 17/673,015

(22) Filed: Feb. 16, 2022

(51) Int. Cl. H04L 9/32; G06Q 10/06

(52) U.S. Cl. CPC H04L 9/3236; G06Q 10/06315; H04L 2209/38

(57) ABSTRACT

Provided is a system and method for collaboratively managing asset data on a blockchain ledger. The asset data may be event-related data, for example, maintenance (e.g., orders, operator notes, solutions, etc.) data and machine and/or equipment data associated with the maintenance. The blockchain ledger may also be searched for recommendations to address a new issue with an asset. In one example, the method may include receiving a notification from an asset of a new occurrence of an event at the asset, identifying a parent block on a blockchain ledger based on a type of the event, generating a new block for the blockchain ledger that comprises alphanumeric content of the new occurrence of the event, and committing the new block with the new occurrence of the event to the blockchain ledger with a hash pointer to the parent block based on the type of event.

### BACKGROUND

Organizations that own and control assets (e.g., industrial assets such as pumps, turbines, windmills, locomotives, aircraft, etc.) typically expend significant resources to maintain the assets. This is because proper care and maintenance can significantly increase the life of an asset. While each organization may strive for the best maintenance practices in an effort to prevent the asset from failing, there are usually gaps between what the organization knows and what the general industry knows. In many cases, the same asset is operated by multiple different organizations. However, these organizations have no way feasible way to share their maintenance data, and their maintenance best practices and policies. Furthermore, the maintenance data may include sensitive proprietary data of the organization that they do not wish to share with outside entities.

As a result, organizations are typically limited to using their own silo of data for determining how to maintain their assets. For assets that have multiple different parts that can each experience multiple different issues, it is difficult to create a holistic maintenance strategy to cover all possible combinations of failure. There are also occasions where an organization may fail to recognize an impending failure to an asset because of a lack of ability to do so resulting in significant costs. For example, for newly purchased assets, the organization may not have any maintenance history to go on, requiring the organization to develop a maintenance strategy from scratch through trial and error.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1 is a diagram illustrating a blockchain network that manages maintenance data from assets on a collaborative basis in accordance with an example embodiment.

FIG. 2A is a diagram illustrating a process of receiving asset data and committing it to a blockchain ledger in accordance with an example embodiment.

FIG. 2B is a diagram illustrating a blockchain ledger which includes multiple blockchains dedicated to multiple different assets in accordance with an example embodiment.

FIGS. 3A-3C are diagrams illustrating examples of a blockchain ledger in which occurrences of maintenance are stored as blocks on a blockchain based on a type of issue associated with the maintenance data, in accordance with example embodiments.

FIG. 4 is a diagram illustrating a process of recommending solutions to an issue with an asset in accordance with an example embodiment.

FIG. 5 is a diagram illustrating a method of managing a collaborative blockchain ledger for asset maintenance data in accordance with an example embodiment.

FIG. 6 is a diagram illustrating a computing system for use in the examples herein in accordance with an example embodiment.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown but is to be accorded the widest scope consistent with the principles and features disclosed herein.

The example embodiments are directed to a modified blockchain architecture that enables a blockchain to be used to efficiently track and search data associated with industrial assets such as machine, equipment, vehicles, aircraft, submersibles, software, etc., used to carry out industrial activities. The asset data may include documents and notes related to the maintenance / upkeep of the asset, for example, maintenance orders, tickets, work orders, diagnostics gathered from the asset, operator notes, digital twin information, etc. The asset may include a turbine, a winch, a windmill, a pump, an aircraft, a locomotive, etc.

A blockchain ledger is commonly used for executing financial transactions among untrusting participants. A blockchain network that hosts the blockchain ledger typically includes multiple blockchain peers (e.g., dozens of peers, hundreds of peers, thousands of peers, etc.) distributed throughout different geographic locations. Each peer may store a copy of the blockchain ledger, participate in the management of the blockchain ledger, and be a gateway for new blockchain transactions to be submitted to the blockchain ledger.

Before a blockchain transaction can be committed, the blockchain transaction typically goes through a blockchain consensus process via the blockchain peers of the blockchain network. When the consensus is successful, the new blockchain transaction is added to a new block (the next block to be stored on the blockchain) based on an order in which the new transaction was received with respect to other new blockchain transactions. When the block reaches its limit of transactions / data size, or some other condition such as a timer expires, the new block is then closed (or cut) and distributed to and committed by the blockchain peers throughout the blockchain network. Each new block that is added to the blockchain includes a hash pointer to the immediately previous block stored on the blockchain. This essentially creates a sequence of links similar to a chain. The blocks end up arranged one-by-one in a sequential order.

Meanwhile, for non-blockchain transactions, timestamps are traditionally used to determine an order among the transactions. For example, correct ordering of financial transactions this way prevents problems with a corresponding bank account such as withdrawing more than is available in the account. This type of ordering may be performed by a centralized system such as a bank computer, central bank etc. In contrast, a blockchain is distributed in nature. Different peers (which may be dispersed throughout large geographic areas), each may include a copy and may participate in managing the blockchain ledger.

In order for timestamps to work as a means for ordering distributed data, the distributed peers must have matching system clocks otherwise the timestamps will not match. However, synchronizing the system clocks of a large group of the blockchain peers distributed in such a blockchain network can be very difficult. In addition, parallel blockchain transactions can be submitted at different blockchain peers (often in parallel / simultaneously). As a result, timestamps may not be a very reliable source for ordering blockchain transactions with respect to each other. Problems can occur because one peer may generate a timestamp and another peer may not be able to confirm it.

In contrast, the example embodiments are directed to a blockchain ledger that stores non-financial transactions, and in particular, maintenance data associated with assets. The blockchain ledger and architecture described herein enables different intermediate blocks in the blockchain to selectively be used as parent blocks. Accordingly, a new child block can be appended to one of multiple different possible parent blocks. In addition, the structure may be limited such that a child block can only be appended to one parent block. Furthermore, the same parent block may have multiple child blocks appended directly thereto. The result is a modified blockchain structure.

The example embodiments can use the modified blockchain structure to track issues associated with an asset, for example, from multiple different data sources. Here, the multiple different data sources may include one or more of a manufacturer of the asset, organizations that own one or more of instance the asset, and the like. Each organization / entity that owns a copy or an instance of the asset may control a blockchain peer in the blockchain network described herein along with the manufacturer. Thus, data about the asset may be pooled together from the multiple different organizations and the manufacturer and added to the blockchain ledger described herein. For example, maintenance related data (e.g., maintenance orders, requests, operator notes, diagnostics, digital twin data, issue resolution data / notes, etc.) may be pooled together from different organizations and stored together within a blockchain.

As events such as maintenance-related events, issues, resolutions, etc. occur at an asset, the asset or a computer connected to the asset such as an asset controller may send event data to the blockchain ledger. The event data may include maintenance orders, operator notes that are scanned from a document, pulled from a user interface, etc., tickets submitted for work orders, resolutions performed, steps taken to resolve the events, and the like. In some embodiments, a human may submit the maintenance-related event data via a user interface. As another example, the maintenance-related event data may automatically be collected by the asset itself (e.g., diagnostics, reports, operating conditions, etc.) and sent to the blockchain.

The blockchain described herein can be built in such a way that each occurrence of an event is represented as a new child block. Where the child block is appended to the blockchain may depend on a type of the event. For example, for a pump that has four parts including a bearing, a casing, a piston, and an impeller, each of these four parts may be represented as their own parent block on the blockchain. When a new event occurs associated with the bearing, the event data may be sent as part of a notification to the blockchain which detects the part (e.g., the bearing) associated with the event, creates a new child block with alphanumeric content of the event, and appends the new child block to a parent block corresponding to the detected part. Thus, the location or part of the asset where the event occurs can dictate where the blockchain adds the event data to the blockchain ledger.

The content from the event may be included in the notification, retrieved from the blockchain ledger, retrieved from the asset, retrieved from a third-party source such as website, etc. and added to the blockchain as a child block of the parent block. For example, the block content may include the maintenance relate data, etc. associated with that respective occurrence of the issue. Because the blockchain is storing non-financial data, the timestamps / orders in which the blocks are added to the blockchain ledger may not be as important as matching together occurrences of the issue. In this case, the blockchain ledger described herein may be referred to a maintenance asset ledger (MAL) that can be searched as a historical database of asset events based on the types of events. Because the order of the blocks is not critical, blocks can be attached to different intermediate blocks on the blockchain (not necessarily the last block in the chain) without regard for the other blocks that have come before. Furthermore, multiple blocks can be appended to the same parent block. The blockchain is essentially a network of blocks where each parent block can be parent to N child blocks.

In addition, the modified blockchain described herein can be searched in a new way. For example, a new instance of the asset may query the blockchain ledger for information about a particular issue with a particular part of the asset. As an example, a new owner of a pump of a particular model number may query the blockchain ledger for information about an impeller problem of other pumps with that same model number. In response, the blockchain ledger may use asset-specific data of the request to query the modified blockchain. For example, the model number may be used to identify a blockchain ledger, and the issue type may be used to identify a parent block. Next, the blockchain can retrieve the block content of all child blocks (e.g., issues, etc.) that depend from the identified parent block.

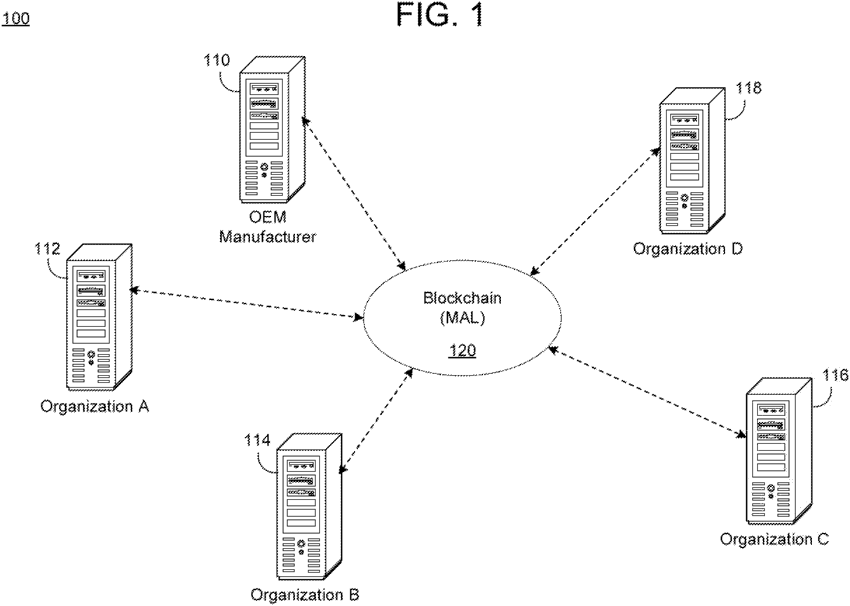

FIG. 1 illustrates a blockchain network 100 that manages maintenance data from assets on a collaborative blockchain ledger in accordance with an example embodiment. Referring to FIG. 1, the blockchain network 100 includes a plurality of blockchain peers 110, 112, 114, 116, and 118, which manage a blockchain ledger 120 that stores maintenance-related data. In this example, the blockchain peers 110, 112, 114, 116, and 118 correspond to the manufacturer of the asset, and owners of four instances of the asset. In some embodiments, the blockchain may be restricted to managing data from a particular model number or type of the asset. As one example, the blockchain ledger 120 may store a blockchain that is dedicated to a Type Z Windmill. Here, each of the blockchain peers 112, 114, 116, and 118 may correspond to owners of a Type Z Windmill, and the blockchain peer 110 may correspond to the manufacturer of the Type Z Windmill.

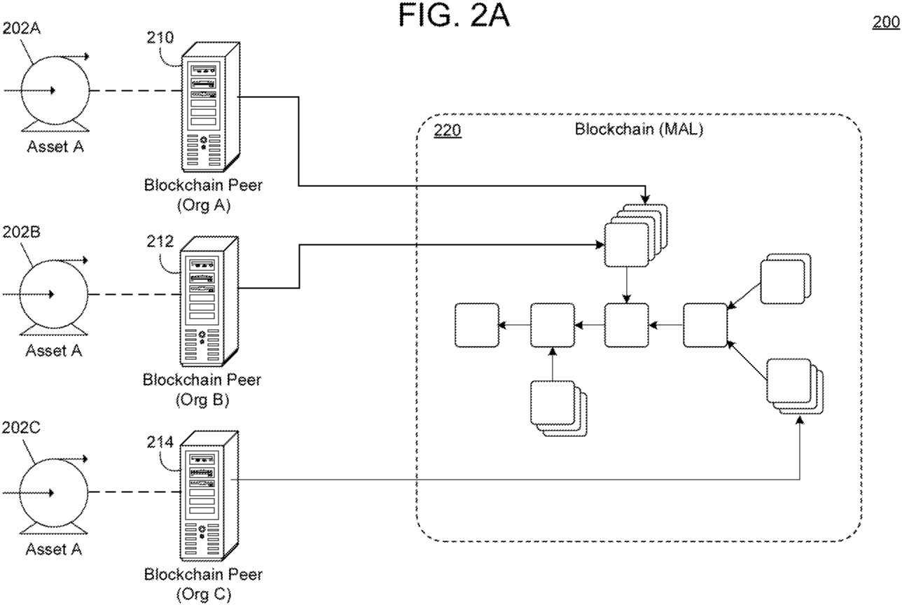

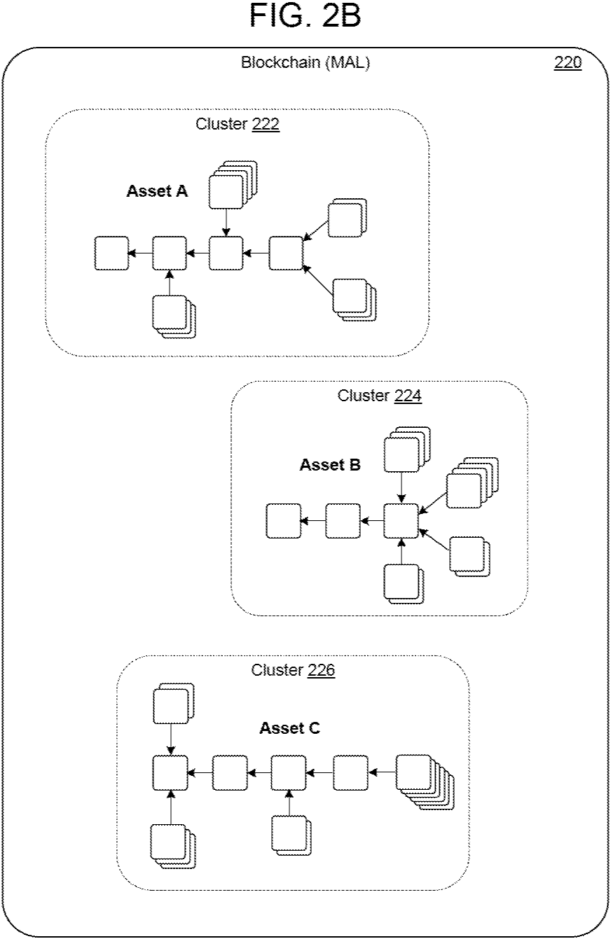

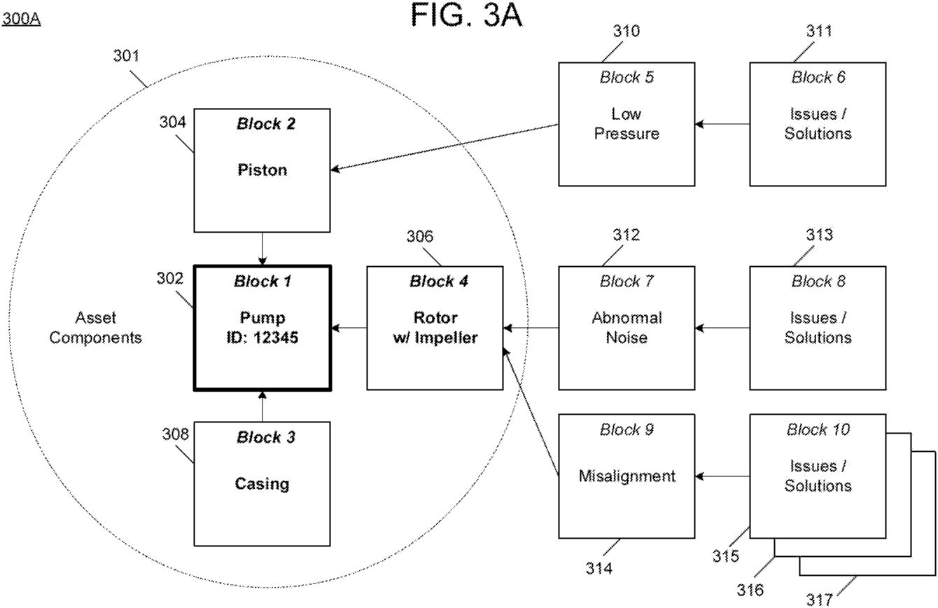

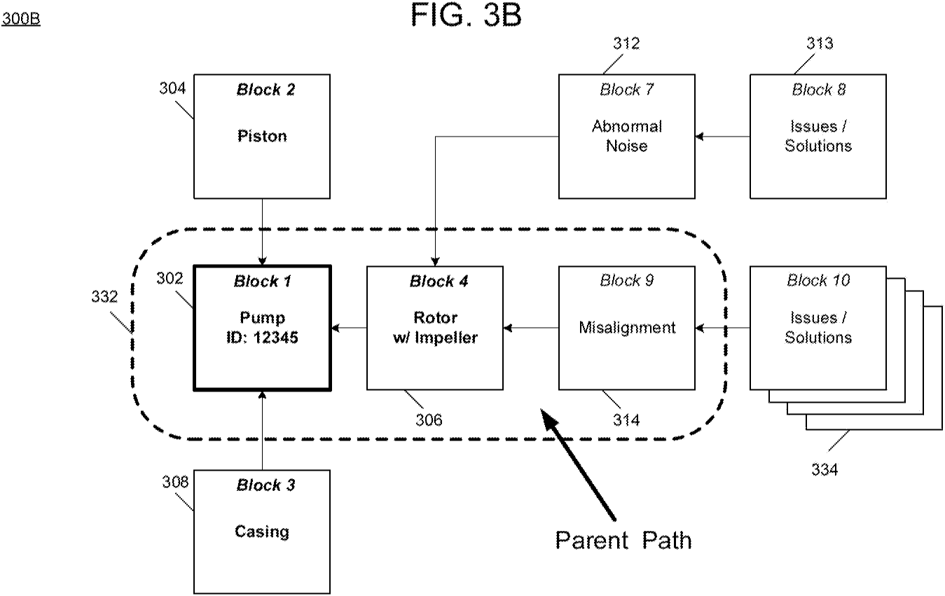

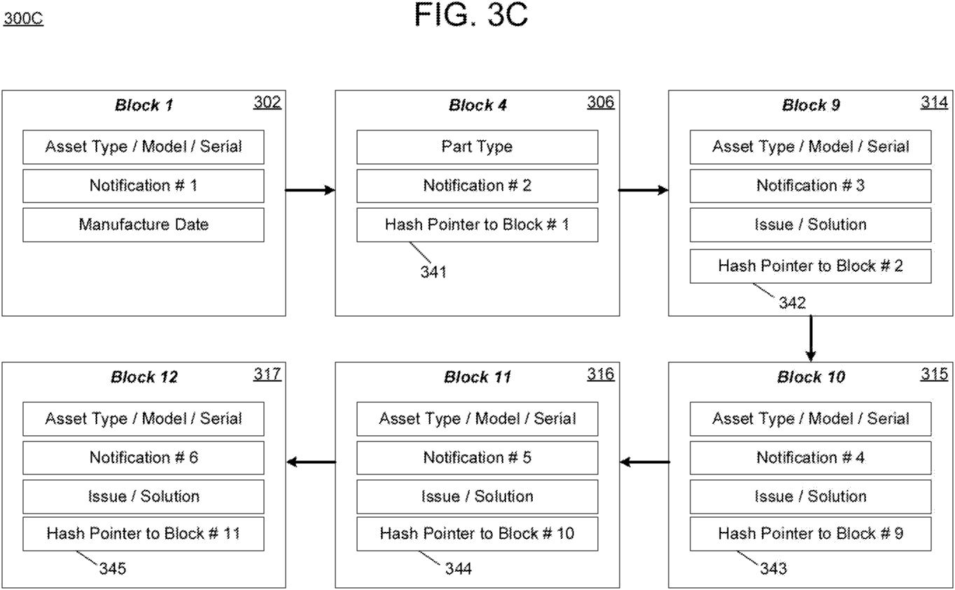

Assets may forward data to any of the blockchain peers 110, 112, 114, 116, and 118 for storage on the blockchain ledger 120. Furthermore, each of the blockchain peers 110, 112, 114, 116, and 118 may be assigned their own public / private key from the blockchain and participate in blockchain activities using such keys for encryption and decryption. As further described below in the examples of FIGS. 2A-2B and 3A-3C, a blockchain structure may be newly defined to efficiently store maintenance-related data of the asset on the blockchain ledger 120 such that it can easily be found and accessed. Here, a blockchain may be created for a particular asset. The blockchain may include a sequence of blocks arranged in any way where each block represents a part of the asset. These initial blocks may be used as parent blocks for child blocks that can store issue information of the asset based on the part of the asset where the issue occurred.

FIG. 2A illustrates a process 200 of receiving asset data (such as maintenance-related data) and committing it to a blockchain ledger 220 in accordance with an example embodiment. Referring to FIG. 2A, a blockchain peer 210 owns a first instance 202A of an asset, a blockchain peer 212 owns a second instance 202B of the asset, and a blockchain peer 214 owns a third instance 202C of the asset. As events / maintenance occur at the first instance 202A of the asset, second instance 202B of the asset, and the third instance 202C of the asset, the event / maintenance information can be provided to the blockchain peers 210, 212, and 214, respectively. When any of the blockchain peers 210, 212, or 214 detect a new occurrence of a type of event to a respective instance of the asset, they may create a new block and add it to the blockchain ledger 220 at a location of the blockchain based on the type of issue such as the part involved in the issue, or the like.

Here, each blockchain peer 210, 212, and 214 may mine blocks to the blockchain ledger 220, and in particular, to a blockchain that is directed to the type of asset (for example a brand name and model number, etc.) that corresponds to the first instance 202A of the asset, the second instance 202B of the asset, and the third instance 202C of the asset. Thus, each instance of the asset can cause changes to a same / common blockchain. Messages may be sent from the assets themselves or from computers / servers that are connected to or otherwise used in association with the asset instances.

For example, an event (e.g., maintenance issue, etc.) may occur at the first instance 202A of the asset. Information about the occurrence of the event at the first instance 202A of the asset may be provided to the blockchain peer 210. Here, the event occurrence data may include maintenance orders, tickets, resolutions, operator notes, diagnostics, and the like. In response to detecting an occurrence of an issue with respect to the first instance 202A of the asset, the blockchain peer 210 can create a new block and submit it to the blockchain ledger 220 which is specific to that occurrence of the issue. Likewise, blockchain peers 212 and 214 may perform the same role as the blockchain peer 210, based on data received from the second instance 202B of the asset and the third instance 202C of the asset, respectively.

FIG. 2B illustrates the blockchain ledger 220 which includes multiple blockchains dedicated to multiple different assets in accordance with an example embodiment. Referring to FIG. 2B, three different blockchains or clusters 222, 224, and 226 may be created on the blockchain ledger 220 for three different assets (A, B, and C). The three different assets may be three different types of assets (e.g., a pump, a turbine, a locomotive, etc.). As another example, the three different assets may be three pumps created by the same manufacturer with three different model numbers, etc. Many different permutations are possible. By creating the blockchain ledger 220 in this way, maintenance information about the different assets can be accumulated on the blockchain ledger 220. Furthermore, the blockchain ledger 220 can be searched when information about an issue is requested.

FIGS. 3A-3C illustrate examples of a blockchain ledger in which occurrences of maintenance are stored as blocks on a blockchain based on a type of issue associated with the maintenance data, in accordance with example embodiments. FIG. 3A illustrates a blockchain 300A which is disposed on a blockchain ledger (not shown) that is distributed among multiple blockchain peers of a blockchain network that manages maintenance data for a particular asset such as the blockchain peers 110, 112, 114, 116, and 118 shown in FIG. 1.

In the example of FIGS. 3A-3C, the asset is a pump. In FIG. 3A, the blockchain 300A includes a plurality of parent blocks 302, 304, 306, and 308 which are directed to the pump (block 302) and three parts of the pump including a piston (block 304), a rotor (block 306), and a casing (block 308). These parent blocks are enclosed by a circle 301 just for purposes of illustration. New child blocks can be appended to any of the parent blocks 302, 304, 306, and 308. It should be appreciated that the pump may include other parts, which may include parent blocks on the blockchain. Each of the parent blocks 302, 304, 306, and 308 may serve as parents to multiple child blocks on the blockchain (i.e., 1 to N). Likewise, multiple child blocks may be attached to one parent block (N to 1). However, each child block may only be appended to a single block (i.e., 1 to 1). The “appending” may include storing a hash pointer in the child block that points to the parent block. Here, the hash pointer may be a hash of content from inside the parent block such as the block number, a block header, block content, and the like, of the parent block.

Different paths of issues may exist. In FIG. 3A, child blocks 310 and 311 depend from parent block 304 (directed to a piston of the pump). Meanwhile, child blocks 312 and 313 depend from block 306 (directed to a rotor of the pump). Furthermore, child blocks 314 and 315 depend from parent block 308 (also directed to the rotor of the pump). In addition to the occurrences of issues, the child blocks may also include identifiers of a type of issue. For example, blocks 312 and 314 are directed to different issues (abnormal noise vs. misalignment). Each type of issue may include its own child block that depends from the parent block 308. Likewise, one or more additional child blocks representing occurrences of the type of issue may be appended to the parent block 308. In this example, there has been one occurrence of an issue associated with noise and the rotor (block 313). In addition, there have been three occurrences of an issue associated with the misalignment of the rotor (blocks 315, 316, and 317).

With this structure, the blockchain 300A can be used to quickly retrieve issue / resolution data when an issue arises with an asset. In particular, the blockchain 300A can be searched for issues related to the pump. For example, if an issue with a rotor is detected on a newly installed pump, the pump or a computer associated with the pump may submit a request / notification with an identifier of the pump represented by block 302. In response, a blockchain peer may receive the notification from the asset (or a computer associated with the asset), detect the identifier of the pump, and use the identifier to identify the blockchain 300A directed to such a pump. Furthermore, the notification may also include an identifier of the issue (or other event) associated with the asset, for example, a notice that a rotor of the pump is making too much noise. In this case, the blockchain peer may detect the parent block 306 as being directed to the rotor and child block 308 as being directed to the event of abnormal noise. Furthermore, the blockchain peer may retrieve content from any child blocks appended to the parent block 306 such as the child block 313 including alphanumeric content describing a similar issue / resolution to another instance of the pump owned and operated by a different organization.

According to various embodiments, a blockchain peer may untangle or otherwise examine the attached child blocks and identify various issues that are represented by individual paths. For example, there are four child blocks attached to the parent block 314 in FIG. 3B. Each child block may be represented by their own block path that is extracted from the blockchain ledger. For example, blocks 302, 306, and 314 may form a parent path for each of the four child blocks, however, only one child block may be appended to each path to create four paths. For example, for block 334, the blockchain path would be a four-block path identified (i.e., block 302, 306, 314, and 334, etc.). Each child block may have its own respective path untangled and examined.

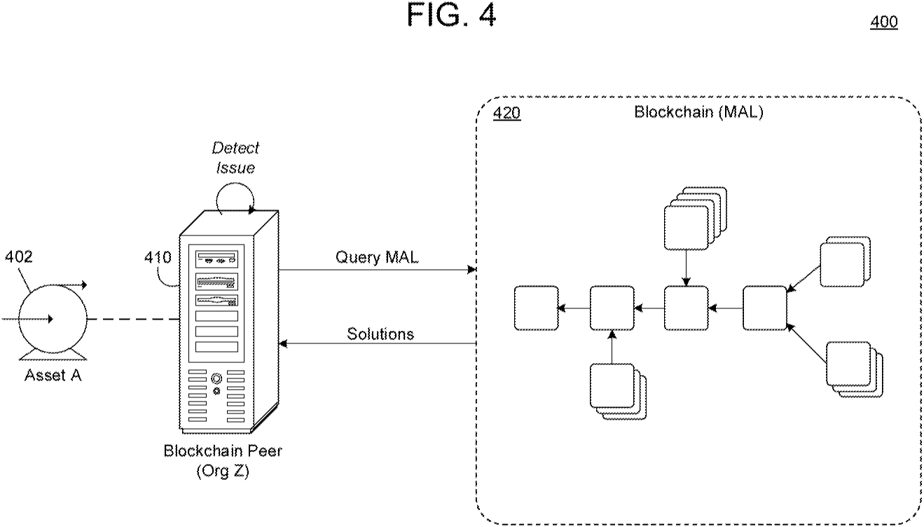

FIG. 4 illustrates a process 400 of searching a blockchain ledger 420 based on a query from an asset 402 to a blockchain peer 410. Here, the query may include an identifier of one or more of an asset type, a part of the asset, a type of issue of the part / asset, an identifier of the asset itself, and the like. In response, the blockchain peer 410 may query a blockchain ledger 420 based on the request / query from the asset 402. For example, a blockchain smart contract, application programming interface (API), or the like, may be invoked to read data from and write data to the blockchain ledger 420. Here, the blockchain peer 410 may use the identifier of the asset as well as information about the issue to retrieve the content from child blocks associated with the same issue (i.e., previous occurrence of the same issue to the same part of the same asset, etc.) The previous occurrences of the issue may have occurred to other instances of the pump that are owned / operated by other entities.

Referring again to FIG. 3A, in response to receiving a query about the pump, the blockchain peer 410 (shown in FIG. 4) can use the identifier of the pump to identify the blockchain 300A dedicated to the pump. Also, the blockchain peer 410 may detect which part from among the parts stored in the parent blocks 304, 306, and 308 are directed to the issue, and then use a corresponding path of a child block(s) off of the identified parent block to identify content associated with the issue stored in any child blocks appended to the parent block.

FIG. 3B illustrates a path 332 on a blockchain 300B that is detected by the blockchain peer when adding a new occurrence of an issue (as a child block 334) to the blockchain 300B. In this case, the content of the issue can be used to identify a path 332 of parent blocks including block 302 directed to the pump / asset, block 306 directed to the rotor (the part where the issue is happening) and block 314 corresponding to the type of issue associated with the part. This allows the blockchain peer to quickly identify that the new child block 334 should be appended to parent block 314. Here, each occurrence of a particular issue with a particular part may lead to a new block being appended to a parent block corresponding to the issue/part combination. In this example, the path 332 includes the block 306 with part data, block 314 with a type of issue with the part, and block 334 now appended to block 314 as an occurrence of the type of issue represented by block 314 and with the part represented by block 306.

FIG. 3C illustrates a string of blocks 302, 306, 314, 315, 316, and 317 linked to each other through hash pointers via a blockchain 300C. Here, the blocks are not consecutive (e.g., block numbers 1, 4, 9, 10, 11, 12, and 13). However, a path between the blocks 302, 306, 314, 315, 316, and 317 can be detected by the blockchain peer because of the hash pointers 341, 342, 343, 344, and 345. Furthermore, the issues / solution data stored in the blocks 314, 315, 316, and 317 can be accumulated / aggregated and provided to an asset or to a computer device associated with the asset. For example, the content associated with the issues / resolutions retrieved from the blockchain 300C can be used to display information about possible solutions via a user interface of such a computer device. In addition, one or more analytics may be performed, for example, machine learning, statistical learning, artificial intelligence, etc. on the issues /resolutions to provide a suggested / recommended solution based on the new issue.

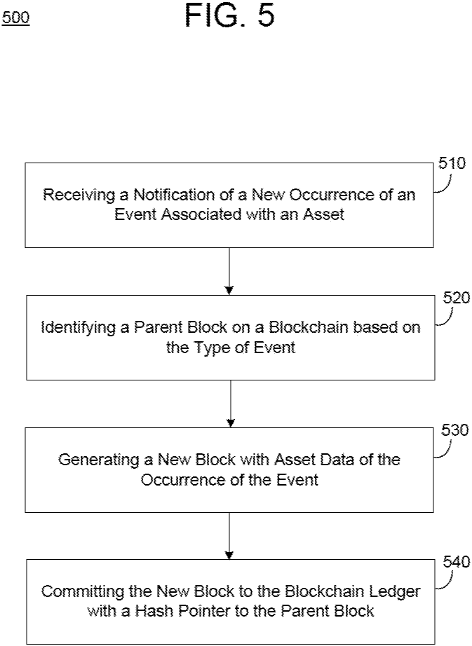

FIG. 5 illustrates a method 500 of managing a collaborative blockchain ledger for asset maintenance data in accordance with an example embodiment. For example, the method 500 may be performed by a blockchain peer, a database node, a virtual machine, a smart contract, a combination thereof, and the like. Referring to FIG. 5, in 510, the method may include receiving a notification of an occurrence of an event of an asset and alphanumeric content associated with a first type of issue of the asset. For example, the notification may include information / data associated with an issue with an asset. The asset may be a physical industrial machine (e.g., windmill, pump, a transformer, an aircraft, a train, a turbine, etc.) As another example, the asset may be a software asset such as an application, a service, a program, etc.

In 520, the method may include identifying a parent block on a blockchain ledger based on the first type of issue. In 530, the method may include generating a new block for the blockchain ledger that comprises the identification of the asset and the alphanumeric content associated with the first type of issue of the asset. In 540, the method may include committing the new block to the blockchain ledger with a hash pointer to the parent block based on the first type of issue of the asset.

In some embodiments, the identifying may include identifying a blockchain ledger assigned to the asset from among a plurality of blockchain ledgers assigned to a plurality of assets, respectively, and identifying a parent block on the identified blockchain ledger which corresponds to the first type of issue of the asset from among a plurality of potential parent blocks which correspond to a plurality of types of issues of the asset, respectively. In some embodiments, the method may further include receiving a second notification from the asset which comprises an identification of the asset and alphanumeric content associated with a second type of issue of the asset and identifying a different parent block on the blockchain ledger which corresponds to the second type of issue of the asset. In some embodiment, the method may further include generating a second new block for the blockchain ledger which includes the identification of the asset and the alphanumeric content associated with the second type of issue of the asset and committing the second new block to the blockchain ledger with a hash pointer to the different parent block which corresponds to the second type of issue of the asset.

In some embodiments, the method may further include receiving a second notification from a different instance of the asset which comprises an identification of the asset and alphanumeric content associated with a second instance of the first type of issue of the asset. In some embodiments, the method may further include generating a second new block that comprises the identification of the asset and the alphanumeric content of the second instance of the first type of issue of the asset and committing the second new block to the blockchain ledger with a hash pointer to the identified parent block which corresponds to the first type of issue of the asset.

In some embodiments, the method may further include receiving a notification from a different instance of the asset which includes a notice of an occurrence of the first type of issue with respect to the different instance of the asset. In some embodiments, the method may further include identifying a plurality of blocks that comprises direct hash pointers to the parent block of the first type of issue of the asset, retrieving alphanumeric content describing solutions to the first type of issue of the asset from the plurality of blocks, and transmitting the retrieved alphanumeric content to the different instance of the asset.

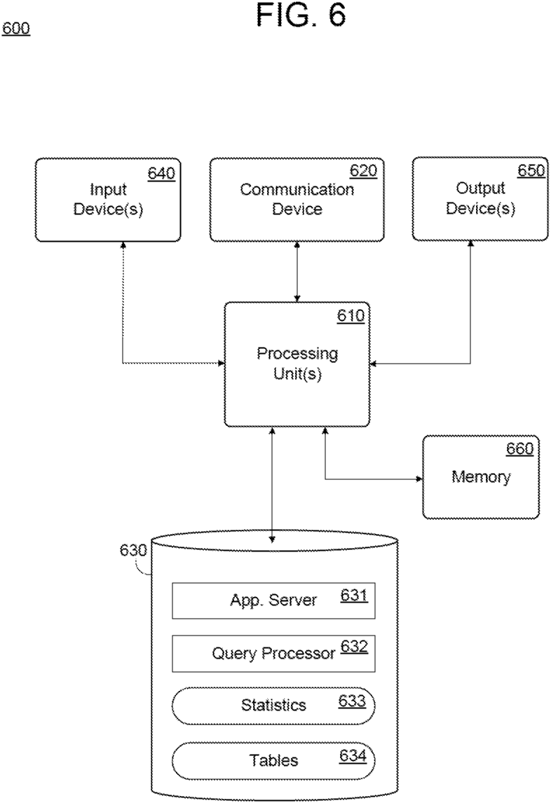

FIG. 6 is a diagram of a server node 600 according to some embodiments. The server node 600 may include a general-purpose computing apparatus and may execute program code to perform any of the functions described herein. The server node 600 may comprise an implementation of a remote terminal or a host platform, in some embodiments. It should also be appreciated that the server node 600 may include other unshown elements according to some embodiments and may not include all of the elements shown in FIG. 6. The server node 600 may perform the method 500 shown in FIG. 5.

Server node 600 includes processing unit(s) 610 (i.e., processors) operatively coupled to communication device 620, data storage device 630, input device(s) 640, output device(s) 650, and memory 660. Communication device 620 may facilitate communication with external devices, such as an external network or a data storage device. Input device(s) 640 may comprise, for example, a keyboard, a keypad, a mouse or other pointing device, a microphone, knob or a switch, an infra-red (IR) port, a docking station, and/or a touch screen. Input device(s) 640 may be used, for example, to enter information into the server node 600. Output device(s) 650 may comprise, for example, a display (e.g., a display screen) a speaker, and/or a printer.

Data storage device 630 may comprise any appropriate persistent storage device, including combinations of magnetic storage devices (e.g., magnetic tape, hard disk drives and flash memory), optical storage devices, Read Only Memory (ROM) devices, etc., while memory 660 may comprise Random Access Memory (RAM). In some embodiments, the data storage device 630 may store user interface elements in tabular form. For example, one or more columns and one or more rows of user interface elements may be displayed in a two-dimensional spreadsheet, table, document, digital structure, or the like.

Application server 631 and query processor 632 may each comprise program code executed by processing unit(s) 610 to cause server node 600 to perform any one or more of the processes described herein. Such processes may include estimating a selectivity of a query on tables 634 based on statistics 633. Embodiments are not limited to execution of these processes by a single computing device. Data storage device 630 may also store data and other program code for providing additional functionality and/or which are necessary for operation of server node 600, such as device drivers, operating system files, etc.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, external drive, semiconductor memory such as read-only memory (ROM), random-access memory (RAM), and/or any other non-transitory transmitting and/or receiving medium such as the Internet, cloud storage, the Internet of Things (IoT), or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

What is claimed is:

1. A computing system comprising:
a network interface configured to receive a notification from an asset of a new occurrence of an event at the asset; and
a processor configured to
identify a parent block on a blockchain ledger based on a type of event;
generate a new block for the blockchain ledger that comprises alphanumeric content of the new occurrence of the event; and
committing the new block with the new occurrence of the event to the blockchain ledger with a hash pointer to the parent block based on the type of event.

2. The computing system of claim 1, wherein the processor is configured to identify a blockchain ledger assigned to the asset from among a plurality of blockchain ledgers assigned to a plurality of assets, respectively, and identify the parent block from the identified blockchain ledger based on the type of event associated with the asset from among a plurality of parent blocks which correspond to a plurality of types of events at the asset, respectively.

3. The computing system of claim 1, wherein the network interface is configured to receive a second notification from the asset which comprises alphanumeric content associated with a new occurrence of a different type of event at the asset and identify a different parent block on the blockchain ledger which corresponds to the different type of event of the asset.

4. The computing system of claim 3, wherein the processor is configured to generate a second new block for the blockchain ledger which includes an identification of the asset and the alphanumeric content associated with the new occurrence of the different type of event and commit the second new block to the blockchain ledger with a hash pointer to the different parent block based on the different type of event.

5. The computing system of claim 1, wherein the network interface is further configured to receive a second notification from a different instance of the asset which comprises a new occurrence of the type of event.

6. The computing system of claim 5, wherein the processor is further configured to generate a second new block that comprises an identification of the asset and alphanumeric content of the new occurrence of the type of event and commit the second new block to the blockchain ledger with a hash pointer to the identified parent block based on the type of event.

7. The computing system of claim 1, wherein the network interface is further configured to receive a search request associated with the type of event from a different instance of the asset.

8. The computing system of claim 7, wherein the processor is further configured to identify a plurality of child blocks that comprises direct hash pointers to the parent block of the type of event, retrieve alphanumeric content from the child blocks describing solutions to the type of event from the plurality of child blocks, and transmit the retrieved alphanumeric content to the different instance of the asset.

9. A method comprising:
receiving a notification from an asset of a new occurrence of an event at the asset;
identifying a parent block on a blockchain ledger based on a type of the event;
generating a new block for the blockchain ledger that comprises alphanumeric content of the new occurrence of the event; and
committing the new block with the new occurrence of the event to the blockchain ledger with a hash pointer to the parent block based on the type of event.

10. The method of claim 9, wherein the identifying comprises identifying a blockchain ledger assigned to the asset from among a plurality of blockchain ledgers assigned to a plurality of assets, respectively, and identifying the parent block from the identified blockchain ledger based on the type of event associated with the asset from among a plurality of parent blocks which correspond to a plurality of types of events at the asset, respectively.

11. The method of claim 9, wherein the method further comprises receiving a second notification from the asset which comprises alphanumeric content associated with a new occurrence of a different type of event at the asset and identifying a different parent block on the blockchain ledger which corresponds to the different type of event of the asset.

12. The method of claim 11, wherein the method further comprises generating a second new block for the blockchain ledger which includes an identification of the asset and the alphanumeric content associated with the new occurrence of the different type of event and committing the second new block to the blockchain ledger with a hash pointer to the different parent block based on the different type of event.

13. The method of claim 9, wherein the method further comprises receiving a second notification from a different instance of the asset which comprises a new occurrence of the type of event.

14. The method of claim 13, wherein the method further comprises generating a second new block that comprises an identification of the asset and alphanumeric content of the new occurrence of the type of event and committing the second new block to the blockchain ledger with a hash pointer to the identified parent block based on the type of event.

15. The method of claim 9, wherein the method further comprises receiving a search request associated with the type of event of a different instance of the asset.

16. The method of claim 15, wherein the method further comprises identifying a plurality of child blocks that comprises direct hash pointers to the parent block of the type of event, retrieving alphanumeric content from the child blocks describing solutions to the type of event from the plurality of child blocks, and transmitting the retrieved alphanumeric content to the different instance of the asset.

17. A non-transitory computer-readable medium that includes instructions which when executed by a processor cause a computer to perform a method comprising:
receiving a notification from an asset of a new occurrence of an event at the asset;
identifying a parent block on a blockchain ledger based on a type of the event;
generating a new block for the blockchain ledger that comprises alphanumeric content of the new occurrence of the event; and
committing the new block with the new occurrence of the event to the blockchain ledger with a hash pointer to the parent block based on the type of event.

18. The non-transitory computer-readable medium of claim 17, wherein the identifying comprises identifying a blockchain ledger assigned to the asset from among a plurality of blockchain ledgers assigned to a plurality of assets, respectively, and identifying the parent block from the identified blockchain ledger based on the type of event associated with the asset from among a plurality of parent blocks which correspond to a plurality of types of events at the asset, respectively.

19. The non-transitory computer-readable medium of claim 17, wherein the method further comprises receiving a second notification from the asset which comprises alphanumeric content associated with a new occurrence of a different type of event at the asset and identifying a different parent block on the blockchain ledger which corresponds to the different type of event of the asset.

20. The non-transitory computer-readable medium of claim 19, wherein the method further comprises generating a second new block for the blockchain ledger which includes an identification of the asset and the alphanumeric content associated with the new occurrence of the different type of event and committing the second new block to the blockchain ledger with a hash pointer to the different parent block based on the different type of event.
